(19) United States
(12) Patent Application Publication
(10) Pub. No.: US 2024/0015003 A1
(43) Pub. Date: Jan. 11, 2024

(54) COMPUTER-IMPLEMENTED METHOD FOR PROVIDING AN ENCRYPTED GLOBAL MODEL TRAINED BY FEDERATED LEARNING, COMPUTER PROGRAM AND PROVIDING SYSTEM

(71) Applicant: Siemens Healthcare GmbH, Erlangen (DE)

(72) Inventor: Srikrishna PRASAD, Erlangen (DE)

(73) Assignee: Siemens Healthcare GmbH, Erlangen (DE)

(21) Appl. No.: 18/346,963

(22) Filed: Jul. 5, 2023

(30) Foreign Application Priority Data
Jul. 7, 2022 (EP) 22183495.5

(51) Int. Cl. H04L 9/00; G06N 20/00; H04L 9/08

(52) U.S. Cl. CPC H04L 9/008; G06N 20/00; H04L 9/0869

(57) ABSTRACT

A computer-implemented method for providing an encrypted global model trained by federated learning, comprises providing an initial global model to a first client; training the provided initial global model based on first training data, to generate a first client trained model; determining first client data based on the first client trained model; homomorphically encrypting the first client data based on a first encryption key, wherein the homomorphical encryption of the first client data is based on a matrix multiplication of the first client data and the first encryption key, to generate encrypted first client data; sending the encrypted first client data to a central aggregator; determining the encrypted global model based on the encrypted first client data, wherein determining the encrypted global model comprises aggregating the encrypted first client data with encrypted second client data; and providing the encrypted global model.

### CROSS-REFERENCE TO RELATED APPLICATION(S)

The present application claims priority under 35 U.S.C. § 119 to European Patent Application No. 22183495.5, filed Jul. 7, 2022, the entire contents of which are incorporated herein by reference.

### RELATED ART

For processing large amounts of data, e.g. for training a machine learning algorithm, a common approach is to make use of external resources, in particular, cloud computing resources. For example, training data sets can be stored within cloud storage, and a machine learning algorithm can be trained by a cloud computing processor based on the training data sets.

Machine learning techniques have proven to be best, when operated on huge data sets these. Recent days, applications of machine learning are gaining momentum towards personalized medicine, image guided therapy, treatment planning, medical imaging such as tumor, detection, classification, segmentation and annotation. However, centralized data storage raises data privacy issues, which being major concern for hospital data sharing for collaborative research and improving model efficiency and accuracy.

With rapid progress in distributed digital healthcare platforms, federated learning approaches are gaining lot of traction. Federated learning (FL) is an approach to conduct machine learning without centralizing training data in a single place, for reasons of privacy, confidentiality, or data volume. In federated learning, a model is trained collaboratively among multiple parties, which keep their training dataset to themselves but participate in a shared federated learning process. The learning process between parties most commonly uses a single aggregator, wherein an aggregator would coordinate the overall process, communicate with the parties, and integrate the results of the training process. However, there are many open security and privacy challenges in conducting federated learning process.

Usage of external resources can be hampered in situations where the resource provider should not have access to the training data, for example due to data privacy regulations. In particular, this is a problem for medical data containing protected health information (an acronym is PHI).

A common approach for processing medical data at external resources is anonymizing or pseudonymizing the medical data before storing and/or processing within the external resources. This approach has the disadvantage that it might not be possible to fully anonymize or pseudonymize the data without losing relevant information. For example, if the medical data is a medical imaging dataset based on a computed tomography or a magnetic resonance imaging, the pixel alone could be used for identifying the respective patient (e.g., by volume rendering the data, reconstruction the face of the patient).

Another possibility is to encrypt the data before storing and/or processing the data within the external resources. However, the encrypting operation and the usage of the machine learning algorithm do not necessarily commute, so that it is not possible to use a machine learning algorithm trained via encrypted data (a synonym is “ciphertext”) for drawing conclusions about unencrypted data (a synonym is “plaintext”).

In federated learning process a single or distributed aggregator collects much information from local parties (models running in local hospital sites) involved in federation after an initiated training cycle. For example, weights, meta information, number of data samples or cohort on which it has been trained are collected by the aggregator. For medical machine learning tasks the collection of data is governed by many regulations such as HIPAA, HITRUST and GDPR. Sending of sensitive quantitative metric, data samples or subjects on which local model was trained at a client (e.g. hospital site) to a global untrusted aggregator in a distributed network (untrusted cloud vendor) may raise a privacy and security issue. In particular, any third party who would use the global model from aggregator can easily identify a data set size or subject samples, in a particular hospital site. Also, it possible for untrusted third-party vendor to discover training population size at a particular hospital site or geography. This can be used by the third party to determine private information about a sample size, population and/or financial gain.

A potential solution for this problem is homomorphically encrypting the training data. Homomorphic encryption is a form of encryption that allows computation on ciphertexts, generating an encrypted result which, when decrypted, matches the result of the operations as if they had been performed on the plaintext. A well-known algorithm having multiplicative homomorphic properties is the RSA (acronym for “Rivest, Shamir, Adleman”) public-key encryption algorithm.

However, for decreasing the vulnerability against attacks, a homomorphic encryption scheme should be semantically secure, which in general terms relates to the fact that an adversary should not be able to discover any partial information from a ciphertext. Since RSA is deterministic in its original form, it is not semantically secure. Any attempt to make it probabilistic breaks its homomorphic properties (see e.g. C. Fontaine and F. Galand, “A Survey of Homomorphic Encryption for Nonspecialists”, EURASIP J. on Info. Security 013801 (2007), https://doi.org/10.1155/2007/13801).

### SUMMARY

One or more example embodiments provides a method for efficient and data secure training of a global machine learning model based on federated learning. The problem is solved by the subject matter of the independent claims. Advantageous embodiments are described in the dependent claims and in the following specification.

In the following, solutions according to one or more example embodiments are described with respect to the claimed systems as well as with respect to the claimed methods. Features, advantages or alternative embodiments herein can be assigned to the other corresponding claimed objects and vice versa. In other words, the systems can be improved with features described or claimed in the context of the corresponding method. In this case, the functional features of the methods are embodied by objective units of the systems.

### BRIEF DESCRIPTION OF THE DRAWINGS

The properties, features and advantages, as well as the manner they are achieved, become clearer and more understandable in the light of the following description and embodiments, which will be described in detail in the context of the drawings. This following description does not limit the invention on the contained embodiments. Same components or parts can be labeled with the same reference signs in different figures. In general, the figures are not for scale. In the following:

FIG. 1 displays a flow chart of an embodiment of the method for providing an encrypted global model trained by federated learning,

FIG. 2 displays a data flow of a federated learning system according to one or more example embodiments,

FIG. 3 displays a data flow in a first embodiment of an providing system, and

FIG. 4 displays a data flow in a first embodiment of a providing system.

### DETAILED DESCRIPTION

According to a first aspect, one or more example embodiments relates to a computer-implemented method for providing an encrypted global model trained by federated learning. The method comprises providing, by a central or distributed aggregator, an initial global model to a first client. The method further comprises training of the provided initial global model based on first training data, thereby generating a first client trained model. The first client determines first client data based on the first client trained model, wherein the first client data comprise a matrix of numbers. Furthermore, the first client homomorphically encrypts the first client data based on an encryption key, wherein the encryption key comprises a matrix of numbers, wherein homomorphically encryption is based on a matrix multiplication of the first client data and the encryption key, thereby generating encrypted first client data. According to the method, the first client sends the encrypted first client data to the central aggregator, wherein the central aggregator determines the encrypted global model based on the encrypted first client data, wherein determining the global model comprises aggregating the encrypted first client data with second encrypted client data. The central aggregator provides the encrypted global model.

The method is configured to provide an encrypted global model trained by federated learning. The encrypted global model is in particular homomorphically encrypted. The encrypted model can be decrypted, especially by a client or the central aggregator, wherein the decrypted global model, also named global model, is achieved. The encrypted model, especially the global model, is trained by a distributed multi-party privacy computing, e.g. by federated learning.

Federated learning is a technique to develop a robust quality shared global model with a central aggregator (e.g. central server) from isolated data among many different clients. In a healthcare application scenario, assume there are K clients (nodes) where each client k holds its respective data Dk with nk total number of samples. These clients and/or nodes could be healthcare wearable devices, an internet of health things (IoHT) sensor, or a medical institution data warehouse. The federated learning objective is to minimize a loss function F(ω) based on a given total data n=Σₖ₌₁^{K}nₖ and trainable machine learning weight vectors ω∈ [symbol] ^{d} with d parameters. To minimize the loss function F(ω) equation (1) can be used:

$${min}_{ω ∈ {ℝ}^{d}} F ( ω ) = {\sum }_{k = 1}^{K} \frac{{n}_{k}}{n} {F}_{k} ( ω ) \qquad ( 1 )$$

wherein

$${F}_{k} ( ω ) = \frac{1}{{n}_{k}} {\sum }_{{x}_{i} ∈ {D}_{k}} {f}_{i} ( ω )$$

and fᵢ(ω)=l(xᵢ,yᵢ,ω) denotes the loss of the machine learning model made with parameter a.

The federated learning is preferably based on a FedAvg algorithm. The federated learning is in particular based on t communication rounds, wherein each communication round comprises the phases:

(1) The central aggregator initializes an initial global model with initial weights ωₜ^{g}, which are shared with a group of clients sₜ, which are picked randomly with a fraction of c∈{0,1}.

(2) After receiving the initial global model with weights ωₜ^{g} from the central aggregator each client k∈sₜ conducts local training steps with epoch E on minibatch b∈B of nₖ private data points. The local model parameters are updated with local learning rate η and optimized by minimizing loss function [symbol] .

(3) Once client training is completed, the client k sends back its local model and weights ωₜ₊₁^{k} to the server. Finally, after receiving the local model ωₜ₊₁^{k} from all selected groups of clients sₜ, the aggregator updates the ωₜ₊₁^{g} global model by averaging of local model parameters using equation (2):

$${ω}_{t + 1}^{g} ← {\sum }_{k = 1}^{K} {α}_{k} \times {ω}_{t + 1}^{k} \qquad ( 2 )$$

where αₖ is a weighting coefficient to indicate the relative influence of each client k on the updating function in the global model, and K is the total clients that participated in the training process. Choosing the proper weighting coefficient αₖ in the averaging function can help improve the global model's performance.

The client k, especially first client k=1, can use this algorithm to generate the k client data, especially first client data, wherein the k client data comprise a k client trained model ωₜ₊₁^{k}. Preferably, the client k (e.g. first client) trains the received initial global model ωₜ^{g} based on the epoch E and minibatch b∈B and generates the client trained model ωₜ₊₁^{k}, e.g. the first client trained model ωₜ₊₁¹. In particular, the client, especially the first client, homomorphically encrypts its client data, e.g. the first client data, based on an encryption key. For example, the client data comprises a vector, matrix or tensor comprising the weights of the client trained model ωₜ₊₁^{k} e.g. the Ck=((ωₜ₊₁^{k})₁, (ωₜ₊₁^{k})₂, . . . (ωₜ₊₁^{k})ᵢ), wherein i denotes the number of weights of the client trained model ωₜ₊₁^{k}.

The encryption key comprises a matrix of numbers, wherein homomorphically encryption is based on a matrix multiplication of the first client data and the encryption key, thereby generating encrypted first client data. The homomorphically encryption is in particular based on a matrix multiplication of the matrix, vector or tensor of the client data, in particular comprising the weights of the client trained model ωₜ₊₁^{k} with the encryption key. The client sends its encrypted first client data to a central aggregator. The central aggregator determines the encrypted global model based on the encrypted first client data, especially based on the generated and/or sent encrypted client data. In particular, the central aggregator determines the encrypted global model based on the encrypted first client data without decrypting the encrypted first client data and/or encrypted client data. The central aggregator provides the encrypted global model.

Determining the global model comprises aggregating the encrypted first client data with second encrypted client data and/or with encrypted client data of further clients, wherein the clients sent their encrypted client data comprising the corresponding trained client model to the central aggregator.

Determining the global model, especially the aggregation, can be based on the following example of a homomorphic federated averaging algorithm, which is described in pseudo code. Herein T denotes the global round, C denotes the number of fractions for each training round, K denotes the number of clients, η denotes the learning rate at a local client, E denotes the number of epochs at a local client, B denotes the local minibatch at a local client and DK denotes the secret key of client K.

Initialize encrypted global model E(ωₜ^{g})=0 for each round t=1, 2, 3, . . . , T.

### Do

m←max(C*K,1)

Sₜ←(m clients in random order)

For each client k∈Sₜ

$$E ( {ω}_{t + 1}^{k} ) ← Client upatede ( k , E ( {ω}_{t}^{g} ) )$$

$$E ( {ω}_{t + 1}^{g} ) ← {\sum }_{k = 1}^{K} {α}_{k} \times E ( {ω}_{t + 1}^{k} )$$

Client update (k,E(ωₜ^{g}))

ωₖ←Sₖ_{₁}⁻¹*E(ωₜ^{g})*Sₖ_{ₙ}⁻¹

For each local epoch e=1,2,3, . . . , E do for each local batch b∈B do

ωₖ←ωₖ−η∇ [symbol] (b;ωₖ)

E(ωₖ)←Sₖ_{₁}*E(ωₜ^{g})*Sₖ_{ₙ}

Return local model E(ωₖ)
Output: E(ωₜ₊₁^{g}) a global model at round t+1

Optionally, the method can comprise a step of transmitting the encryption key from the client, especially the first client, to the central aggregator and/or in opposite direction. In particular, this step of transmitting can be executed in an encrypted way, e.g., by using asymmetric encryption.

In particular, the first client data, especially the matrix of numbers, are configured as plaintext data and/or comprise data, weights and/or metadata of a machine learning algorithm and/or comprise data about the training data. In particular, the first client data comprises training input data for the machine learning algorithm and/or for the training of the local and/or global model. The first client data may comprise respective ground truth data.

In particular, a matrix of numbers is a matrix of (negative and/or positive) integers, of rational numbers or of real numbers. In particular, a matrix of integer numbers can be a matrix of elements of a finite field. In particular, a matrix is a rectangular array of those numbers, arranged in rows and columns. A row vector is a matrix with only one row, and a column vector is a matrix with only one column. The term “vector” refers to either a row vector or a column vector. A number can be interpreted as a matrix with one row and one column. In particular, the first plaintext matrix of numbers comprises at least two rows and/or at least two columns. In particular, the word matrix is also used for and/or understood as vector or tensor.

In particular, the encrypted first data, especially encrypted first client data, comprises a matrix of numbers (also denoted as “first encrypted matrix of numbers”). In particular, the encrypted first client data can be equal to said matrix of numbers. In particular, the first encrypted matrix of numbers is a matrix over the same field as the matrix of the first client data. In particular, the first encrypted matrix of numbers has the same number of rows and/or the same number of columns as the matrix of the first client data.

In particular, the encrypted global model comprises a matrix of numbers (also denoted as “encrypted processed matrix of numbers”). In particular, the encrypted global model is equal to said matrix of numbers.

In particular, the encrypted global model comprises a matrix of numbers (also denoted as “global model matrix of numbers”). In particular, the encrypted global model can be equal to or be fully described by said matrix of numbers. In particular, the matrix of the encrypted global model is a matrix over the same field as the matrix of the encrypted first client data. In particular, the matrix of the encrypted global model has the same number of rows and/or the same number of columns as the matrix of the encrypted first client data.

In particular, the clients, especially the first client, are different entities from central aggregator. In particular, the clients, especially the first client, is spatially separated from the central aggregator. In particular, the central aggregator can be a cloud processing entity or a server processing entity.

The inventors recognized that by using a method according to one or more example embodiments an initial global model can be trained on the clients and aggregated on a central aggregator, without the central aggregator having the possibility to access plaintext data, information about the training, training sides, sample sides and/or metadata of the training. Furthermore, encryption based on a matrix multiplication is very efficient, in particular, due to the use of an integer encryption key, since integer operations can be executed faster than floating point operations. Furthermore, since machine learning algorithms and models can often be expressed in terms of linear algebra calculations, the encryption and decryption process can efficiently be used for machine learning algorithms.

According to a further aspect of one or more example embodiments the method comprises receiving, by the central aggregator, encrypted second client data, which are sent by the second client. The encrypted second client data comprise a matrix of numbers. In particular, the second client generates and/or determines the encrypted second client data analogous and/or in a similar was as the first client generates and/or determines the encrypted second client data. Preferably, further clients, e.g. a third client, fourth client, etc., determines client data and provides them to the central aggregator. In particular, the central aggregator provides the initial global model to the second client and/or further clients. The second client, especially the further, trains the provided initial global model based on second or further training data, thereby generating a second or further client trained model. The second client determines second client data based on the second client trained model, wherein the second client data comprise a matrix of numbers. The second client homomorphically encrypts the second client data based on an encryption key, wherein the encryption key comprises a matrix of numbers, wherein homomorphically encryption is based on a matrix multiplication of the second client data and the encryption key, thereby generating encrypted second client data. In a same way the further clients can determine and/or generate encrypted further client data. The second client and/or the further clients send the encrypted second and/or further client data to the central aggregating entity for determining the encrypted global model.

In particular, the step determining first client data based on the first client trained model, comprises determining a matrix of model weights as the matrix of numbers. In other words, the first client trains the initial global model and adapts the weights of the model, wherein the client determines as the matrix of numbers comprised by the first client data a matrix comprising the adapted weights. The first client determines for example the weights (ωₜ₊₁)_{d} with d=1, 2, . . . , D, wherein the first client determines as the matrix of model weights the vector A=((ωₜ₊₁¹)₁, (ωₜ₊₁¹)₂, (ωₜ₊₁¹)₃, . . . , (ωₜ₊₁¹)_{D}).

Preferably the step determining first client data based on the first client trained model comprises determining a matrix of metadata as the matrix of numbers, wherein the metadata comprise a population size, number of data samples or cohort on which it has been trained. In other words, the first client trains the initial global model and adapts the weights of the model based on its training data, minibatch b and/or local data. The client determines herein an matrix, especially vector, comprising an information about the sample size of the training data and/or of the minibatch, an information about the population size of local data and/or of local training data and/or an information about the cohort of the training. E.g., the first client determines as matrix the vector AM1=(|b|, |Yx|), wherein |b| denotes the size of the minibatch b and |Yx| denotes the number of data samples manifesting the attribute x.

Particularly, the step determining the encrypted global model based on the encrypted first client data comprises linear combination of the encrypted first client data with encrypted second client data and/or with encrypted further client data. For example, the first client sends the matrix or vector E(A1) as encrypted first client data and the second client sends the matrix or vector E(A2) as encrypted second client data, the central aggregator determines the encrypted global model based on α₁*E(A₁)+α₂*E(A₂). In case clients k=1, 2, . . . , K send encrypted k client data E(Ak) the central aggregator can determine the encrypted global model based on Σₖ₌₁^{K}αₖE(Aₖ).

Optionally, the central aggregator determines an encrypted processed matrix based on a matrix multiplication of the encrypted first client data with the encrypted second client data and/or with encrypted further client data. E.g., the central aggregator determines as the encrypted processed matrix E(A)=ΠₖE(Aₖ). The encrypted processed matrix E(A) is provided, especially to at least one client, wherein the client can decrypt the encrypted processed matrix.

The inventors recognized that by using encrypted data from a second client data can be processed at the central aggregator, without the central aggregator being able to access the plain data.

In particular at least one client, e.g. the first client or second client, receives the encrypted global model from the central aggregator. In other words, the central aggregator sends the encrypted global model to the client. The receiving client decrypts the received encrypted global model based on a matrix multiplication of the encrypted global model and the inverse of the encryption key, thereby generating global model. The decrypted and/or generated global model is provided and/or used by the client, e.g. used for routine application or further training of the global model.

Preferably, the method further comprises generating a random integer matrix and determining a unimodular integer matrix, wherein the matrix product of the unimodular integer matrix and the random integer matrix equals the hermite normal form of the random integer matrix (RIM). Furthermore, the method comprises a step of determining the encryption key, wherein the encryption key comprises the matrix product of the unimodular integer matrix, of an exchange matrix and of the inverse of the unimodular integer matrix. The encryption key is provided to the first client, second client, client and/or central aggregator.

In particular, the matrices, vector and/or tensors of the first client data and/or the second client data are matrices with integer or float numbers. Especially, the first client data, the second client data and/or the further client data are plain text data. Preferably, the first client data, the second client data, the further client data and/or the encryption key are matrices over a finite field.

According to a preferred embodiment of the invention, the method further comprises receiving, by the first client, the encrypted global model from the central aggregator. E.g., the central aggregator sends the encrypted global model to the first client. Herein, the first client decrypts the encrypted global model, thereby generating the global model. The first client verifies the generated global model.

According to a further aspect of one or more example embodiments the encrypted first client data and/or the encrypted second client data are matrices of numbers, wherein aggregating the encrypted first client data and/or the encrypted second client data comprises at least one of the following operations: inversion of the encrypted first client data and/or the encrypted second client data, scalar multiplication of a number and the encrypted first client data and/or the encrypted second client data, addition or subtraction of the encrypted first client data and/or the encrypted second client data, and matrix multiplication of the encrypted first client data and/or the encrypted second client data.

The inventors recognized that by said operation all linear algebra operations based on the encrypted first client data and/or the encrypted second client data can be created. At the same time, due to the homomorphic encryption, also all linear algebra operations based on the first client data and/or the second client data can be executed by encrypting the data, processing the encrypted client data at the central aggregator, and decrypting the data again.

In particular, the federated learning and/or global model is based on machine learning model and/or can comprise a neural network, a support vector machine, a decision tree and/or a Bayesian network, and/or the machine learning model can be based on k-means clustering, Q-learning, genetic algorithms and/or association rules. In particular, a neural network can be a deep neural network, a convolutional neural network or a convolutional deep neural network. Furthermore, a neural network can be an adversarial network, a deep adversarial network and/or a generative adversarial network.

According to a further aspect of one or more example embodiments the step of determining the encryption key comprises generating a random integer matrix and determining a unimodular integer matrix, wherein the matrix product of the unimodular integer matrix and the random integer matrix equals the hermite normal form of the random integer matrix. According to this aspect, the encryption key comprises the matrix product of the unimodular integer matrix, of an exchange matrix and of the inverse of the unimodular integer matrix. In particular, the result of this matrix product is an involuntary matrix.

In particular, a random integer matrix is a matrix of integers, wherein each entry is a random integer. In particular, the random distribution of each entry of the random integer matrix is independent from the other entries of the random integer matrix (in other words, the entries of the random integer matrix are statistically independent). In particular, each entry of the random integer matrix is equally distributed.

A unimodular matrix is a square integer matrix having determinant +1 or −1. Equivalently, a unimodular matrix is an integer matrix that is invertible over the integers, in other words, there is an integer matrix that is its inverse.

An exchange matrix is an anti-diagonal matrix with the counter-diagonal entries being 1 and all other entries being 0. For arbitrary fields, “1” is equivalent to the neutral element of the multiplicative operation, and “0” is equivalent to the neutral element of the additive operation. Synonyms for “exchange matrix” are “reversal matrix”, “backward identity matrix”, and/or “standard involutory permutation matrix”.

The inventors recognized that the matrix product of the unimodular integer matrix, of an exchange matrix and of the inverse of the unimodular integer matrix is an involuntary integer matrix. By using encryption keys based on involuntary integer matrices, there is no need for a dedicated calculation of a matrix inverse for the involuntary matrix, so that the effort of encrypting and decrypting is reduced. Furthermore, calculations with integer matrices are computational faster than with floating point numbers. This is of particular relevance if also the plaintext data can be represented as integer matrices (e.g. in the case of image data, wherein each pixel can comprise an integer intensity value).

According to a further aspect, one or more example embodiments relates to a providing system for providing an encrypted global model trained by federated learning, comprising a first client, preferably a second and/or further clients, and an central aggregator,
wherein the first client is configured for receiving an initial global model,
wherein the first encryption entity can be configured for determining an encryption key, the encryption key comprising an integer matrix,
wherein the first client is configured for training of the provided initial global model based on first training data, thereby generating a first client trained model,
wherein the first client is configured for determining first client data based on the first client trained model, wherein the first client data comprise a matrix of numbers,
wherein the first client is configured for homomorphically encrypting the first client data based on an encryption key, wherein the encryption key comprises a matrix of numbers, wherein homomorphically encryption is based on a matrix multiplication of the first client data and the encryption key, thereby generating encrypted first client data,
wherein the first client is configured for sending the encrypted first client data to a central aggregator,
wherein the central aggregator is configured for determining the encrypted global model based on the encrypted first client data, wherein determining the global model comprises aggregating the encrypted first client data with encrypted second client data,
wherein the central aggregator is configured for providing the encrypted global model.

In particular, the providing system is configured for executing the method for providing an encrypted global model trained by federated learning according to one or more example embodiments and its aspects.

According to a third aspect, one or more example embodiments relates to a computer program comprising instructions which, when the program is executed by a providing system, cause the providing system to carry out the method according to one or more example embodiments and its aspects.

According to a fourth aspect, one or more example embodiments relates to a computer-readable medium comprising instructions which, when executed by a providing system, cause the providing system to carry out the method according to the invention and its aspects.

The realization of one or more example embodiments by a computer program product and/or a computer-readable medium has the advantage that already existing providing systems can be easily adopted by software updates in order to work as proposed by one or more example embodiments.

The computer program product can be, for example, a computer program or comprise another element apart from the computer program. This other element can be hardware, for example a memory device, on which the computer program is stored, a hardware key for using the computer program and the like, and/or software, for example a documentation or a software key for using the computer program.

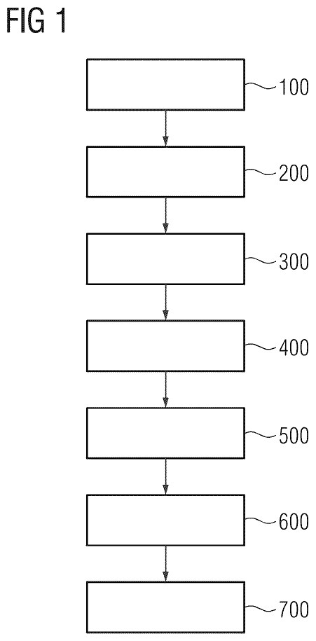

FIG. 1 display flow chart of an embodiment of the method for providing an encrypted global model trained by federated learning according to the invention. The data flow is between clients 1 and a central aggregator 2.

Within the embodiment displayed in FIG. 1, the central aggregator 2 provides in step 100 to the client 1, especially to the first client 1, an initial global model. The initial global model is a machine learning model. Especially, the initial global model is a global model which is already trained, wherein this global model is further trained by using it as initial global model to generate an optimized global model. The machine learning model is configured to carry out a task, especially to analyze and/or process input data based on the global model. E.g., the global model is configured for analyzing medical imaging data or patient data. In particular, the central aggregator 2 provides the initial global model to the clients 1 as encrypted global model, wherein the clients decrypt the provided encrypted global model and use it as provided global model. The decryption of the encrypted global model in the clients 1 is for example achieved by multiplication with an inverse of a encryption key.

In step 200 of the method the first client 1a trains the provide initial global model. Herein the first client 1a trains the global model based on local first training data, e.g., a minibatch B. Also the other clients 1, e.g. second and further clients 1, train the provided initial global model based on local training data. The training of the initial global model at the clients results in and/or generates client trained models, e.g. first client trained model, second client trained model and/or further client trained model.

In step 300 each client 1, especially the first client 1, determine client data, especially first client data. The client 1 determines the client data based on its client trained model. Each client data comprises a matrix of numbers, in particular the client data are configured as the matrix of numbers. The matrix of numbers preferably comprises the weights of the client trained model and/or describes the client trained model.

The client 1 homomorphically encrypts the client data based on an encryption key in step 400. The encryption key is provided to the client 1, e.g., by the central aggregator or a third party. Alternatively, the encryption key is determined and/or generated by the client 1. The encryption key comprises a matrix of numbers or is configured as such a matrix of numbers. The homomorphically encryption is based on a matrix multiplication of the client data and the encryption key, wherein encrypted client data are generated.

In step 500 of the method the clients 1 sent their encrypted client data to a central aggregator 2. The central aggregator 2 collects the encrypted client data, e.g., stores them in a data storage.

In step 600 the central aggregator 2 determines and/or generates an encrypted global model based on the encrypted client data, wherein determining the global model comprises aggregating the provided encrypted client of the clients 1.

The central aggregator 2 provides the encrypted global model in step 700. The central aggregator provides it for example to clients, e.g. as initial global model, or to a third party.

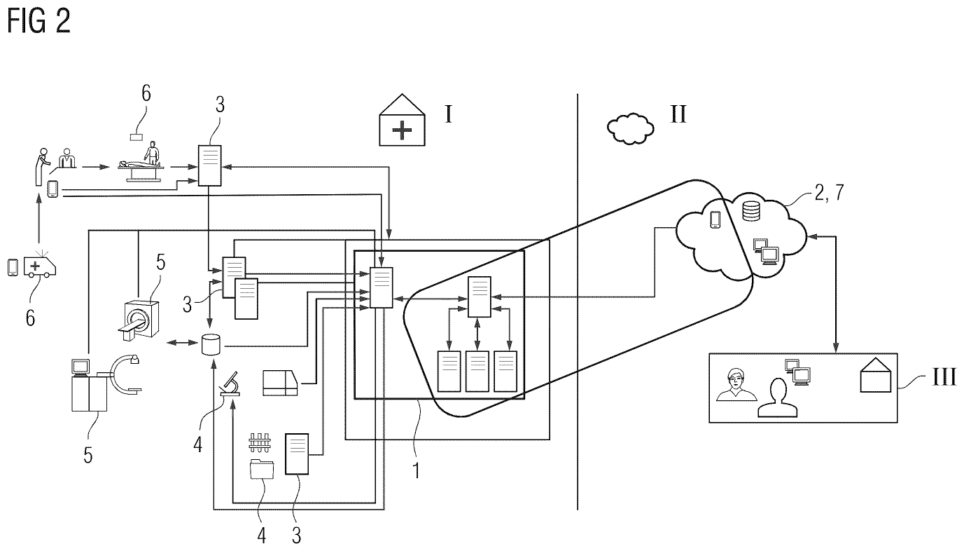

FIG. 2 shows an example of a system configured for federated learning, e.g. a providing system. The system can be split in two general parts I, II, wherein I is a network inside the hospital and II is a network outside the hospital, e.g. the central aggregator 2.

At the hospital a hospital I information system 3 collects data from different entities, e.g. form a lab 4, medical imaging devices 5 and/or from a parametric app 6. The hospital network comprises a client 1. The hospital information system 3 provides the collected data to the client 1, which uses the provided data as training data. The client 1 implements and/or supports the method according to one or more example embodiments a trains at the hospital side a provided initial global method.

The client 1 sends the encrypted first client data to the network outside the hospital II, e.g., to a cloud server 7. The cloud server 7 is configured as global aggregator 2 and determines based on the provided encrypted first client data and on further provided encrypted client data an encrypted global model. The central aggregator 2 provides the encrypted global model to a third party III, e.g., another hospital. A verification 8 of the matrix C3 can be implemented and/or executed by the central aggregator 2 and/or client 1.

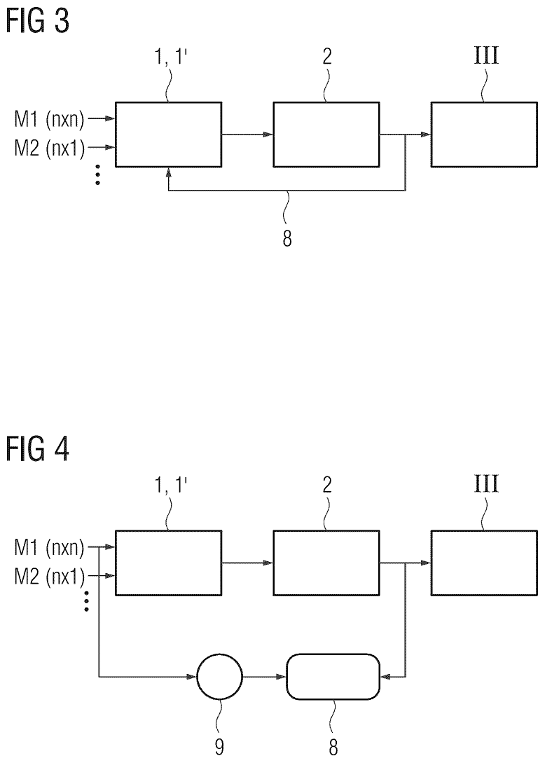

FIG. 3 shows a block diagram illustrating a providing system with homomorphic multiplication. The first client 1 provides pairs of weights and metadata, wherein the first client 1 provides the weights as matrix M1 and provides metadata as matrix M2. The client 1 encrypts the data as plain text matrices with secret key A and generates the matrices C1 and C2. At the central aggregator 2 multiplication of the matrices C1, C2 is executed, wherein the matrix C3 is generated. The matrix C3 is provided to a third party 8. The third party 8 decrypts the matrix C3 based on the secret key A.

FIG. 4 shows a providing system, which is basically configured as described for FIG. 3. wherein the system of FIG. 4 comprises a key generator to generate and/or calculate the secret key A by a key generator 9.

The encryption key A can by calculated by the key generator 9, the client 1 or the central aggregator, based on a random integer matrix RIM and a unimodular integer matrix UIM.

The central aggregator 2, the clients 1, the key generator 9 and/or the providing system can use the following beneficial relations.

In particular, if A denotes the encryption key being an integer n×n-matrix, R denotes the random integer n×n-matrix R, and U denotes the unimodular integer n×n-matrix UIM. U is chosen so that H=U·R, wherein H is an upper triangular (that is, Hij=0 for i>j) matrix with any rows of zeros are located below any other row, wherein for H the leading coefficient (the first nonzero entry from the left, also called the pivot) of a nonzero row is always strictly to the right of the leading coefficient of the row above it and the leading coefficient is is positive, and wherein for H the elements below pivots are zero and elements above pivots are nonnegative and strictly smaller than the pivot. For given R, the matrices H and U can be calculated even in polynomial time, see e.g. R. Kannan and A. Bachem: “Polynomial Algorithms for Computing the Smith and Hermite Normal Forms of an Integer Matrix”, SIAM Journal on Computing. 8:4 (1979), doi:10.1137/0208040, pp. 499-507.

The matrix A being the encryption key can then be determined as A=U·IF·U−1, wherein IF is the exchange n×n-matrix with IF, ij=1 for i=n−j+1 and IF, ij=0 otherwise. So A is in fact an involuntary matrix, since A−1=(U·IF·U−1)−1=U−1·IF−1·U=U·IF·U−1=A since IF·IF=id and so IF−1=IF. Using involuntary matrices as encryption key has the advantage that the matrix inversion of these matrices does not need to be calculated separately.

In the following, it will be demonstrated how different linear algebra operations can be performed by client 1 and/or the global aggregator 2. In the following, A will denote the encryption key. In particular, A is an involuntary matrix, implying that A−1=A. The matrices M will denote the matrix of the client data. The encrypted client data, especially the encrypted matrix of the encrypted client data are denoted by C.

### Matrix Inversion

Let M be a n×n-matrix, and let A be an involuntary n×n-matrix. The encrypted matrix C can be calculated as C=A·D·A−1. Within the central aggregator or the client provided with the encrypted matrix C, the inverse C−1 of the encrypted matrix C can be calculated. The global model comprised by the encrypted global model can then be calculated based on the matrix A as A−1·C−1−A=A−1·(A·D·A−1)−1−A=D−1.

Alternatively, the encrypted matrix C can be calculated as C=A·D. The inverse C−1 of the encrypted matrix C can be calculated. The global model and/or the decryption of the encrypted matrix C can then be calculated based on the matrix A as C−1−A=(A·D)−1·A=D−1.

### Multiplication of Square Matrices

Let D1 and D2 be n×n-matrices (both corresponding to client data), and let A be an involuntary n×n-matrix (corresponding to the encryption key). The encrypted matrices C1 and C2 can be calculated as C1=A·D1·A−1 and C2=A·D2·A−1, respectively.

Within the cloud computing environment, the product C1-C2 of the encrypted matrices C1 and C2 can be calculated. The decryption can then be calculated based on the matrix A as A−1·C1·C2·A=A−1·A·D1·A−1·A·D2·A−1·A=D1·D2 and is in fact equivalent to the product D1·D2.

Alternatively, the encrypted matrices C1 and C2 can be calculated as C1=A·D1 and C2=D2·A−1, respectively. The decryption can then still be calculated based on the matrix A as A−1·C1·C2·A=A−1·A·D1·D2·A−1·A=D1·D2 and is in fact equivalent to the product D1·D2.

### Skalar Multiplication

Let D1 be an m×n-matrix, let d be a scalar number. Furthermore, let A1 be an involuntary m×m-matrix and let A2 be an involuntary n×n-matrix (corresponding to the encryption key). The encrypted matrices C1 can be calculated as C1=A1·D1·A2−1.

Within the central aggregator 2, the scalar product dC1 of the encrypted matrix C1 and the scalar d can be calculated. The decryption can then be calculated based on the matrices A1 and A2 as A1−1·dC1·A2=dA1−1·A1·D1·A2−1·A2=dD1 and is in fact equivalent to the product dD1.

Alternatively, the encrypted matrix C1 can be calculated as C1=A1·D1, and the decryption can be calculated based only on the matrix A1 as A1−1·dC1=dA1−1·A1·D1=dD1 and is in fact equivalent to the product dD1.

### Multiplication of Rectangular Matrices

Let D1 be an k×m-matrix, and let D2 be an m×n-matrix, k, m and n being integers. Furthermore, let A1 be an involuntary k×k-matrix, A2 be an involuntary m×m-matrix and A3 be an involuntary n×n matrix. The encrypted matrices C1 and C2 can be calculated as C1=A1·D1·A2−1 and C2=A2·D2·A3−1, respectively.

Within the central aggregator 2, the product C1·C2 of the encrypted matrix C1 and the encrypted matrix C2 can be calculated. The decryption can then be calculated based on the matrices A1 and A3 as A1−1·C1·C2·A3=A1−1·A1·D1·A2−1·A2·D2·A3−1·A3=D1·D2 and is in fact equivalent to the product D1·D2.

Alternatively, the encrypted matrices C1 and C2 can be calculated as C1=A1·D1 and C2=D2·A3−1, respectively. The decryption can then still be calculated based on the matrices A1 and A3 as A1−1·C1·C2·A3=A1−1·A1·D1·D2·A3−1·A3=D1·D2 and is in fact equivalent to the product D1·D2.

### Sum of Rectangular Matrices

Let D1 and D2 be an m×n-matrices, m and n being integers. Furthermore, let A1 be an involuntary m×m-matrix and let A2 be an involuntary n×n-matrix. The encrypted matrices C1 and C2 can be calculated as C1=A1·D1·A2−1 and C2=A1·D2·A2−1, respectively.

Within the central aggregator, the sum C1+C2 of the encrypted matrix C1 and the encrypted matrix C2 can be calculated based on the matrices A1 and A3 as A1−1·(C1+C2)·A2=A1−1·A1·D1·A2−1·A2+A1−1·A1·D2·A2−1·A2=D1+D2 and is in fact equivalent to the sum D1+D2.

It will be understood that, although the terms first, second, etc. may be used herein to describe various elements, components, regions, layers, and/or sections, these elements, components, regions, layers, and/or sections, should not be limited by these terms. These terms are only used to distinguish one element from another. For example, a first element could be termed a second element, and, similarly, a second element could be termed a first element, without departing from the scope of example embodiments. As used herein, the term “and/or,” includes any and all combinations of one or more of the associated listed items. The phrase “at least one of” has the same meaning as “and/or”.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

Spatial and functional relationships between elements (for example, between modules) are described using various terms, including “on,” “connected,” “engaged,” “interfaced,” and “coupled.” Unless explicitly described as being “direct,” when a relationship between first and second elements is described in the disclosure, that relationship encompasses a direct relationship where no other intervening elements are present between the first and second elements, and also an indirect relationship where one or more intervening elements are present (either spatially or functionally) between the first and second elements. In contrast, when an element is referred to as being “directly” on, connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Also, the term “example” is intended to refer to an example or illustration.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

It is noted that some example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed above. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Specific structural and functional details disclosed herein are merely representative for purposes of describing example embodiments. The present invention may, however, be embodied in many alternate forms and should not be construed as limited to only the embodiments set forth herein.

In addition, or alternative, to that discussed above, units and/or devices according to one or more example embodiments may be implemented using hardware, software, and/or a combination thereof. For example, hardware devices, such as clients and aggregators, may be implemented using processing circuitry such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner. Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor, Central Processing Unit (CPU), a controller, an arithmetic logic unit (ALU), a digital signal processor, a microcomputer, a microprocessor, etc.), the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable recording mediums, including the tangible or non-transitory computer-readable storage media discussed herein.

Even further, any of the disclosed methods may be embodied in the form of a program or software. The program or software may be stored on a non-transitory computer readable medium and is adapted to perform any one of the aforementioned methods when run on a computer device (a device including a processor). Thus, the non-transitory, tangible computer readable medium, is adapted to store information and is adapted to interact with a data processing facility or computer device to execute the program of any of the above mentioned embodiments and/or to perform the method of any of the above mentioned embodiments.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive), solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blu-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as a computer processing device or processor; however, one skilled in the art will appreciate that a hardware device may include multiple processing elements or processors and multiple types of processing elements or processors. For example, a hardware device may include multiple processors or a processor and a controller. In addition, other processing configurations are possible, such as parallel processors.

The computer programs include processor-executable instructions that are stored on at least one non-transitory computer-readable medium (memory). The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc. As such, the one or more processors may be configured to execute the processor executable instructions.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

Further, at least one example embodiment relates to the non-transitory computer-readable storage medium including electronically readable control information (processor executable instructions) stored thereon, configured in such that when the storage medium is used in a controller of a device, at least one embodiment of the method may be carried out.

The computer readable medium or storage medium may be a built-in medium installed inside a computer device main body or a removable medium arranged so that it can be separated from the computer device main body. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

Wherever not already described explicitly, individual embodiments, or their individual aspects and features, can be combined or exchanged with one another without limiting or widening the scope of the described invention, whenever such a combination or exchange is meaningful and in the sense of this invention. Advantages which are described with respect to one embodiment of the present invention are, wherever applicable, also advantageous of other embodiments of the present invention.

1. A computer-implemented method for providing an encrypted global model trained by federated learning, the method comprising:
providing, by a central aggregator, an initial global model to a first client;
training, by the first client, the provided initial global model based on first training data, to generate a first client trained model;
determining, by the first client, first client data based on the first client trained model, wherein the first client data comprise a first matrix of numbers;
homomorphically encrypting, by the first client, the first client data based on a first encryption key, wherein the first encryption key comprises a second matrix of numbers, wherein the homomorphical encryption of the first client data is based on a matrix multiplication of the first client data and the first encryption key, to generate encrypted first client data;
sending, by the first client, the encrypted first client data to the central aggregator;
determining, by the central aggregator, the encrypted global model based on the encrypted first client data, wherein determining the encrypted global model comprises aggregating the encrypted first client data with encrypted second client data; and
providing, by the central aggregator, the encrypted global model.

2. The computer-implemented method of claim 1, further comprising:
providing, by the central aggregator, the initial global model to a second client;
training, by the second client, the provided initial global model based on second training data, to generate a second client trained model;
determining, by the second client, second client data based on the second client trained model, wherein the second client data comprise a third matrix of numbers;
homomorphically encrypting, by the second client, the second client data based on a second encryption key, wherein the second encryption key comprises a fourth matrix of numbers, wherein homomorphical encryption of the second client data is based on a matrix multiplication of the second client data and the second encryption key, to generate the encrypted second client data; and
sending, by the second client, the encrypted second client data to the central aggregator to determine the encrypted global model.

3. The computer-implemented method of claim 1, wherein the determining the first client data comprises:
determining a matrix of model weights as the first matrix of numbers, wherein the model weights are weights of the first client trained model.

4. The computer-implemented method of claim 1, wherein the determining the first client data comprises:
determining a matrix of metadata as the first matrix of numbers, wherein the metadata comprise a population size, number of data samples or cohort on which the initial global model has been trained.

5. The computer-implemented method of claim 1, wherein the determining the encrypted global model comprises:
a matrix multiplication of the encrypted first client data with the encrypted second client data.

6. The computer-implemented method of claim 1, further comprising:
receiving, by a client, the encrypted global model from the central aggregator;
decrypting, by the client, the encrypted global model based on a matrix multiplication of the encrypted global model and an inverse of the first encryption key, to generate a global model; and
providing, by the client, the global model.

7. The computer-implemented method of claim 1, further comprising:
generating a random integer matrix;
determining a unimodular integer matrix, wherein a matrix product of the unimodular integer matrix and the random integer matrix equals a hermite normal form of the random integer matrix;
determining the first encryption key, wherein the first encryption key comprises the matrix product of the unimodular integer matrix, of an exchange matrix and of an inverse of the unimodular integer matrix; and
providing the first encryption key to at least one of the first client, the second client, or the central aggregator.

8. The computer-implemented method of claim 2, wherein at least one of the first client data or the second client data are integer matrices.

9. The computer-implemented method of claim 1, wherein the first client data and the first encryption key are matrices over a finite field.

10. The computer-implemented method of claim 1, further comprising:
receiving, by the first client, the encrypted global model from the central aggregator;
decrypting, by the first client, the encrypted global model, to generate the global model; and
verifying, by the first client, the global model.

11. A providing system for providing an encrypted global model trained by federated learning, comprising:
a first client; and
a central aggregator,
wherein the first client is configured to,
receive an initial global model,
train the received initial global model based on first training data, to generate a first client trained model,
determine first client data based on the first client trained model, wherein the first client data comprise a first matrix of numbers,
homomorphically encrypt the first client data based on an encryption key, wherein the encryption key comprises a second matrix of numbers, wherein homomorphical encryption is based on a matrix multiplication of the first client data and the encryption key, to generate encrypted first client data, and
send the encrypted first client data to the central aggregator,
wherein the central aggregator is configured to,
determine the encrypted global model based on the encrypted first client data, wherein determining the encrypted global model comprises aggregating the encrypted first client data with encrypted second client data, and
provide the encrypted global model.

12. A non-transitory computer-readable medium comprising instructions which, when executed by a providing system, cause the providing system to carry out the method of claim 1.

13. A non-transitory computer-readable medium comprising instructions which, when executed by a providing system, cause the providing system to carry out the method of claim 2.

14. The computer-implemented method of claim 2, wherein the determining the first client data comprises:
determining a matrix of model weights as the first matrix of numbers, wherein the model weights are weights of the first client trained model.

15. The computer-implemented method of claim 14, wherein the determining the first client data comprises:
determining a matrix of metadata as the first matrix of numbers, wherein the metadata comprise a population size, number of data samples or cohort on which the initial global model has been trained.

16. The computer-implemented method of claim 15, wherein the determining the encrypted global model comprises:
a matrix multiplication of the encrypted first client data with the encrypted second client data.

17. The computer-implemented method of claim 16, further comprising:
receiving, by a client, the encrypted global model from the central aggregator;
decrypting, by the client, the encrypted global model based on a matrix multiplication of the encrypted global model and an inverse of the first encryption key, to generate a global model; and
providing, by the client, the global model.

18. The computer-implemented method of claim 17, further comprising:
generating a random integer matrix;
determining a unimodular integer matrix, wherein a matrix product of the unimodular integer matrix and the random integer matrix equals a hermite normal form of the random integer matrix;
determining the first encryption key, wherein the first encryption key comprises the matrix product of the unimodular integer matrix, of an exchange matrix and of an inverse of the unimodular integer matrix; and
providing the first encryption key to at least one of the first client, the second client, or the central aggregator.
